(19) United States
(12) Patent Application Publication
(10) Pub. No.: US 2005/0132069 A1
(43) Pub. Date: Jun. 16, 2005

(54) System and method for the algorithmic disposition of electronic communications

(75) Inventors: Marvin Shannon, Pasadena, CA (US); Wesley Boudville, Perth (AU)

Correspondence Address: MARVIN SHANNON, 3579 EAST FOOTHILL BLVD, #328, PASADENA, CA, 91107, US

(73) Assignees: Marvin Shannon, Pasadena, CA (US); Wesley Boudville, Perth (AU)

(21) Appl. No.: 10/905,037

(22) Filed: Dec. 12, 2004

Related U.S. Application Data
(60) Provisional application No. 60/481,789, filed on Dec. 14, 2003.

(51) Int. Cl. G06F 15/16

(52) U.S. Cl. 709/228

(57) ABSTRACT

From a set of electronic messages, we describe how to use Bulk Message Envelopes (BMEs), each of which collects together closely related or identical messages, to extract metadata. The types of metadata depend on the modality of the messages. For email, these include domain, hash, style, relay and user address. We find clusters in each of these spaces, where the making of the clusters is the same, regardless of the space. The clusters can be used to reveal associations between different elements of that space, where these associations may not be apparent from a simple consideration of the individual, original messages. Specifically, domain clusters can be used to make or augment a Real time Blocking List (RBL), where the domains are found from links in the bodies of the messages. Large RBLs can be easily constructed, in an automated or near-automated fashion; aiding in antispam and antiphishing efforts.

### CROSS REFERENCE TO RELATED APPLICATIONS

This application claims the benefit of the filing date of U.S. Provisional Patent 60/481 745, “System and Method for the Algorithmic Categorization and Grouping of Electronic Communications”. Dec. 5, 2003, and U.S. Provisional Application, No. 60/481 789, “System and Method for the Algorithmic Disposition of Electronic Communications”, filed Dec. 14, 2003. Each of these applications is incorporated by reference in its entirety.

### DETAILED DESCRIPTION

1. DESCRIPTION

2. Technical Field

This invention relates generally to information delivery and management in a computer network. More particularly, the invention relates to techniques for automatically finding associations between elements in various metadata spaces associated with the information.

### BACKGROUND OF THE INVENTION

Historically, Real time Blocking Lists (RBLs) have been an effective means of eliminating spam from corporate email servers with an extremely low to non-existent false positive rate. Their only downside has been the effort needed to compile the lists of domains to be excluded.

In the early days of the Internet it was possible for each administrator to do all of the investigation work for herself, and then administer her RBL accordingly. When the volume of unsolicited email grew to unmanageable levels, administrators started relying on external groups to aggregate email complaints and construct/administer an appropriate RBL for distribution to the community. Now the volume of unsolicited email has reached epidemic proportions; even community-based RBL/anti-spam efforts are staggering under the load. The key problem is the requirement that there be a human-in-the-loop element to the RBL compilation.

Current Methodology

The majority of email related RBLs are currently compiled via submissions by users. For example, the major ISPs, yahoo, hotmail and AOL, have a spam submission button, when the user is reading a given message. So if she considers the message as spam, she can press the button, to inform the ISP. The submissions are then manually analyzed, generally by people at the submission site, to determine if they are actually spam. This is necessary, in part to prevent spammers acting as typical users and nominating regular messages as spam, in order to poison the RBL. Once the ISP makes a determination that a given email is spam, then the sender name, sender domain, and sending relay informations are extracted from the email; and the sender domain/IP-address/CIDR-range and/or the sending relay domain/IP-address/CIDR-range may be added to a block list. One issue that sometimes arises is that spam may be sent from virally compromised host computers in domains belonging to major ISPs or Corporations. In these instances it may not be possible to block the specific sender without blocking a wide swath of innocent users.

The need for human in-the-loop spam determination has made it difficult to construct RBLs in an automated fashion. Attempts to do so would invariably cause the resultant RBL to include various inappropriate domains or IP addresses or CIDR ranges. These RBL inclusions then lead to the exclusion of legitimate email from delivery. These failures are known as “false positives”, which can be particularly annoying, and in some cases devastating, for the intended recipient, who may then not actually receive desired messages. To combat this phenomenon, administrators typically investigate each RBL candidate carefully before adding a domain or IP address or CIDR range to a block list.

### SUMMARY OF THE INVENTION

The foregoing has outlined some of the more pertinent objects and features of the present invention. These objects and features should be construed to be merely illustrative of some of the more prominent features and applications of the invention. Other beneficial results can be achieved by using the disclosed invention in a different manner or changing the invention as will be described. Thus, other objects and a fuller understanding of the invention may be had by referring to the following detailed description of the Preferred Embodiment.

We describe a new methodology for building and managing block/include/exception lists for electronic communications in general, and elucidate the case of an algorithmic email RBL by way of a specific example. The disclosed technology can be largely immune to false positives based on the selection criteria for message disposition relating to the sample set.

The discovery disclosed herein is a process, and an underlying technical utility, for extracting relational data and structured metadata from electronic communications; and exposing correlations that enable the management of the communication streams in important, useful manners. The management facilities encompass language dependent and/or language independent means.

This is achieved by determining relationships between communications that define various relational spaces. For e-mail, as an example of one type of communications space, there are several relational spaces; including, but not limited to:
a) sender domains
b) relay domains
c) content resolution domains
d) click domains
e) canonical hashes
f) senders
g) primary recipients
h) secondary recipients
i) styles
j) temporal distributions

In the system disclosed herein there is no given expectation as to how the initial set of messages is chosen. Any selection criteria are sufficient, but the more related the messages are in any manner of particular interest, the greater the utility of our system/process.

Once a set of messages has been selected for analysis, by whatever means, a series of 0-to-N canonical reduction steps may be applied to the messages. No canonical reduction steps are strictly required, but inasmuch as the steps standardize the message contents for comparison, they may be desirable. Our system described above can also be used when canonical steps are not performed on the messages in order to obtain hashes, or when different canonical steps are done.

One can extract as a data/metadata space any relationship between messages that is quantifiable. One need not extract all spacial relationships present in the communications space (email, for example), or utilize all of the spaces extracted, to derive benefit from this system.

Suppose the former is done. So there is no representation of messages by hashes. But if analysis can be done of the messages to extract representations in other spaces, then our system can still be applied, in whole or part. Possibly with lesser efficacy, because we are now missing the hash space. For one thing, this reduces the possible amount of information in the style space. For example, we have a style attribute which is set true if several canonically identical messages have different subject lines. If no canonical steps are done, then fewer messages will be marked as “same” because of pseudo randomness introduced by a spammer in making unique copies of a given message. So there will be less chance of setting that attribute true for messages. There are other style attributes that also depend on making comparisons between canonically identical messages.

Hence we will have fewer style attributes that may be indicative of spam.

The other case is when different canonical steps are done. Our system can be used as we have described above.

Our canonical reduction, hashing and matching to make metadata is equivalent to a data standardization representation of the original messages. This has several consequences which have utility; amongst them, that archival storage requirements can be greatly diminished. We illustrate this with an example: Suppose we want to store only messages that have more than a certain number of copies. One reason is that if we are looking at email, such messages may be indicative of spam, and we might want to archive them, to have a historical record. This might be, in part, because we want to compare these against new spam, to see any differences. We have found that a typical email spam message is from 3 kb-10 kb. Being able to find and store only one copy, especially of the high multiplicity spam, is a great space saving. The storage can be freed up even more if we are willing to store only our metadata for that message, in place of the message. Typically, if our metadata is stored as XML, it takes up less than one kilobyte.

Utilizing these correlations we can determine relationships between the elements in a defined space, or correlate groups of elements across various defined spaces. For email, as an example of one type of communications space, we could perform various actions (including, but not limited to) the following:
1. determine the existence of canonical duplicates and canonically similar messages in hash space (message hash clusters);
2. extract the domains of entities related to the messages (spammer clusters);
3. users related to various message clusters and/or spammer clusters (mailing list clusters);
4. determine the routing characteristics of messages/message groups and any abnormalities thereof;
5. examine the header characteristics of messages/message groups and looking for any abnormalities thereof.

In the above example of email, we have taken specific metadata types as dependent variables, where the independent variable is the message. Also, in general, we can choose any metadata type and construct clusters of that type, where we treat that type as a dependent variable, and the independent variable can be any of the other metadata types.

With these correlations we can achieve several communications management goals: classification, categorization, routing disposition, in depth analysis of the communications streams, etc. For email, as an example of one type of communications space, one could perform various actions (including, but not limited to) the following:
1. find domains that issue unsolicited bulk email (spam) and thence block incoming email referring to those domains.
2. block all incoming or outgoing electronic communications related to these domains (ping, ftp, http, etc), typically at the mail relay and firewall levels.

Additionally, one can cross-correlate various communications spaces from disparate sources; allowing for the refinement of our understanding of all spaces involved. For example, you could extract the domain link clusters from web sites and correlate them to the click domain clusters from e-mail. This might allow you to determine which domain clusters are so called “link farms”.

The technology we are disclosing here is applicable to other forms of electronic communications as well; including, but not limited to:
a) E-mail and related services
b) Small Message Services (SMS), alphanumeric paging systems, and similar technologies
c) i-Mode, m-Mode, various “rich” messaging services for mobile devices, etc.
d) Instant Messaging (IM) services, and similar technologies
e) digital fax services (corporate fax servers, etc)
f) Unsolicited telephone communications management
g) web-site “reputation” rankings (using domain list for excluding “link farms”)
h) archives of electronic communications All techniques disclosed herein can be utilized effectively in language independent configurations.

### BRIEF DESCRIPTION OF THE DRAWINGS

For a more complete understanding of the present invention and the advantages thereof, reference should be made to the following Detailed Description taken in connection with the accompanying drawings.

### DETAILED DESCRIPTION OF THE PREFERRED EMBODIMENT

What we claim as new and desire to secure by letters patent is set forth in the following claims.

One can apply the general techniques of signal intelligence analysis to any type of communications space. The general properties of any communications space must contain message envelope characteristics that are analytically accessible, even if the message payloads themselves are not accessible/available. The majority of techniques disclosed herein are language independent. This is very useful at two levels. Firstly, if users communicate in a language unknown to the administrators, our system does not depend on this. Secondly, if they use a known language, but use code phrases, our system also does not depend on it. That is to say, while we may not know what the message says, we can look at some of its interaction attributes:
(1) sender(s)
(2) receiver (primary and secondary)
(3) timestamps,
(4) duration of communique,
(5) transmission frequencies (how often),
(6) transmission diversity (sending multiple messages, duplication, etc. . . ),
(7) transmission pathways
(8) external forward and backward references (links, telephone numbers, etc. . . ).

In general, we can successfully utilize attributes of a message that we can relate via a weighted “distance” function to another attribute; or to other instances of itself, if the concept of similarity exists for this attribute.

We can find graphs of messages that are “similar” to a given message, where the user can define what “similar” means. We let the user define a metric (distance measure) in electronic communication, and then search for messages close to the given message, as given by the metric.

We extract metadata in various spaces from the messages. Consider the example of email. Let us start with a given message A. Suppose it has 2 domains, rho and omega. We might define that other messages with these 2 domains are close to A. Then, other messages that only have rho or omega are further away. And messages without rho or omega are not similar at all. Clearly, instead of domains, if we chose another space, we could do likewise.

We can then graph these similar messages, along with the original message, where the messages closest to A in the above space are shown connected to A more closely than messages further away in that space.

But there is an important extension of the above. Continuing the above example, suppose we have a message C that has only one of A's domains. Let the set of messages closest to A be B={B1, . . . , Bn}. We can search amongst this set for a message closest to C, and if there is one such message, we attach C to it on the graph, where we use domains as our primary metric. But suppose several members of B are closest to C, in this sense.We can then choose one of the other spaces as a secondary metric. In this space, we search B for a member closest to C. If we find a unique member, then we attach C to it. What if there are still several Bs closest to C in this secondary space? Suppose these are {B1, B4, B6, B7}. We then choose a third space and see which of these 4 is closest to C. We keep doing this until we reach a single message that is closest to C, or we have exhausted all the spaces. In this last case, we just randomly choose one of the closest Bs and attach C to it.

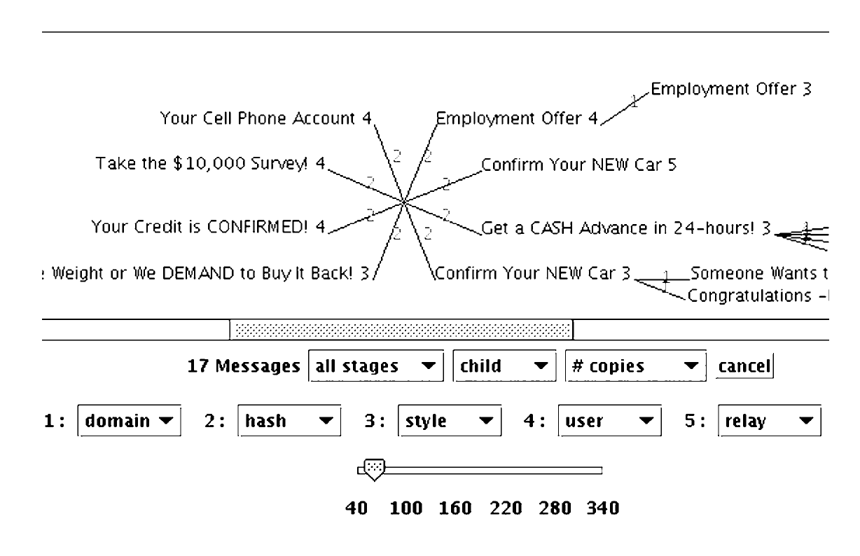

FIG. 1 shows an example. Here original message A is implicitly at the center of the diagram, and there are 8 messages connected to it. The lower part of the figure shows the order in which the metrics are defined. So the 8 messages connected to A have the same domainsas A, while the other messages have only 1 domain in common with A. The second metric is the hash space, followed by style, user and relay. The user can choose any order of these metrics.

The power of a similarity graph is that it lets you search for partial matches in the messages, to find more presumably related messages. Why is this useful? Consider again the case of email and suppose we are trying to find spam. Suppose, somehow, we have found a message A that we definitely consider spam. For example, maybe after reading it, we reached this conclusion. Our method of finding exact canonical copies of A is useful in telling us which of our users got a copy of A. But it may be that the spammer has then sent out other messages selling other items. If these messages also refer to the same spammer domains as did A, and/or if they have similar boilerplate text, then we have a means of also marking these messages as spam.

We can use similarity graphs both manually, for investigation, or in an automated fashion. By either means, we can mark more messages as spam.

Each communications space will have a set of signal attributes particular to that channel modality. With other types of electronic communication, we can define similar spaces. Typically, what will vary are the precise canonical steps and what each style bit means. But in general, we can always define canonical steps and arrive at one or more hashes per message. So we always have a hash space. Thence, we can find any messages with same hashes, and get a user space.

In terms of the spaces, the domain and relay spaces are the most intrinsically associated with email. But in other communications, there may be analogs of these. For example, in IM or SMS messages, the domain space might be replaced or supplemented by the phone number space.

The key concept is that in an electronic communication, if there is a way to embed links in it, so that the recipient can pick these links, then we can programmatically extract the addresses in those links, and use them to define an address space. Such extraction is programmatically possible because by the virtue of these links being selectable, they have to be written in a strict format that lets the display software (the equivalent of a “browser”) make them so.

The browser usage on the World Wide Web has become pervasive throughout the developed world. As a result, people are now used to the idea that an electronic message can contain links to other locations and that you can easily pick those links. This usage expectation is so intuitive and familiar that any new communication language will have to support a similar ability. Thus our system can be used with future languages that electronic communications might be written in.

Such programmatic extraction of addresses is independent of the human language in which the message is written. This is important, because as a practical matter in the marketplace, major existing (and future) computer languages for electronic communication need to be usable to a world wide audience. Antispam systems with human language dependence need to be reworked for each such language. Our system does not.

In general: the basic process is to extract some set of representational spaces from the set of electronic communications, specify a set of criteria, and select the messages that meet that criteria set. This resultant group of messages can then be further processed to yield sets of attributes that are useful for a specific purpose. One pertinent example would be a list of domains that are emitting spam, so that we can block/include emails (or any other electronic communications: i.e., http, ftp, ssh, etc.) related to the domains; and/or promote any electronic communications from these domains for exceptional processing (logging, alerts, analysis, etc.).

In general: additional benefit may be derived by associating the data spaces derived from one communications modality to data spaces derived from other communications modalities and/or information derived from external databases. One pertinent example would be associating the domain spaces derived from email with the domain spacial information derived via analysis of the specified domains (and those related via links to a specified link depth), and possibly the information from the domain registries (this would specify NSP, ISP, hosting, ownership, etc.).

The following are examples of a subset of the current communications spaces to which these techniques are applicable*:
(*see Appendix: A for definition of cluster analysis applied to message-quantized communications)

Ex.1. Email (or archives thereof)

In an earlier Provisional Patent 60320046, “System and Method for the Classification of Electronic Communications”, Mar. 24, 2003, we described how for an electronic message, we can reduce it to a canonical form, make multiple hashes, and then compare these hashes with hashes from other messages. These messages may all be received by the same person, or, more usefully, by several people. In doing so, we can identify messages that occurs several times (have multiplicity greater than one).

In Provisional Patent 60/481 745, we described how we extend the hash analysis to a generalized analysis of all of the data spaces that can be derived from the various electronic communications modality.

In an upcoming pending patent application,“Systems and Method for the Correlation of Electronic Communications” (expected filing date January 2004), we describe how we crawl the web sites associated to the link domains extracted from the bulk message envelopes (BME) related to a given electronic communications modality, to extract the data relevant to verification and enhancement of our mutual understanding of the cross references data spaces. Here we explain how to utilize the crawl-related data spaces to enhance our understanding and increase the reliability of our BME-related data spaces.

In an upcoming pending patent application,“Systems and Method for Advanced Statistical Categorization of Electronic Communications” (expected filing date January 2004) we describe how we utilize purified-data feeds (primarily, via message similarity criteria and BME similarity criteria) and Bayesian (with optionally other statistical approaches) to determine various attributes of electronic communications. These heuristic attributes may not be particularly canonical, but do exhibit signatures that can be used for approximate informational purposes. These techniques are applied to messages, BMEs, and link domain-related informational sources like web sites.

Here we extend these concepts to the creation of a set of data spacial attributes that are used to select an electronic message (or messages) for specialized disposition based on its envelope properties and the intrinsic properties; and possibly, the relationship of those properties to externally derived data spaces and/or databases.

In the discussion that follows, we specialize to the case of email, but our techniques are applicable to any electronic communication.

We also define two messages as the “same” if they are canonically identical.

Email consists of a header and a body. The header has various structured information, like the Subject line, the From line, the To line, the Date line and a list of relays, by which the message arrived. Note that in general, all of this information is purported, except that written by the mail receiving program. The sender might (and often does) have the ability to modify most of the header. And, of course, the sender writes the body.

In contrast to the header, the body is typically considered to be unstructured data [“Proven Portals” by D Sullivan, Addison-Wesley 2004]. But we can programmatically extract structured data from the body. We call the different types of data, “spaces”. Some are from the body, and some are derived from the header.

Currently, we have several spaces: hash, sender domains, relay domains, content resolution domains, link domains, style, sender, recipient, relay, time. More may be added in future. In the following description, for brevity, when we say “domains”, we will mean link domains. These are the domains extracted from links in the messages, that the recipients can select. But the remarks that we make for the link domains are applicable to the other domain spaces.

In this example we want to build a Realtime Blocking List (RBL).

The group of emails to be analyzed can be selected in any manner, so long as the selection criteria are pertinent to the analytical intent. We will use canonical similarity, but other selection criteria could be used. We also define two messages as the “same” if they are canonically identical.

In our Provisional Patent 60320046, “System and Method for the Classification of Electronic Communications”, we discussed how to reduce the body to a canonical form and then make several hashes of it. The hashes form one space. In doing the canonical steps, we analyze various aspects of the message and form an integer, which we call “style”. Various bits represent different stylistic features of the message. So we have a style space. We also find the domains in hyperlinks and HTML submit buttons. These are in the domain space. We get the list of relays in the header, and form the relay space.

A message arrives for a user. Hence we can associate one user with a given message. But by our canonical steps, we can find messages that are canonically identical, across different users. So if several users get the same message, we associate those users with the message. Hence we get a user space.

The time space is the set of times when our mailer received the messages. The temporal spacial attributes allow a time ordered, or time duration view of the various other datum.

The above spaces have the vital property that our extraction methods are independent of the human language in which the body is written. Thus they can be applied to email in any language. This is an important advantage over methods that apply keyword analysis, or attempt to discern semantic information. Such methods are specific to particular languages. For example, an antispam filter that checks for the presence of “free”, “sex”, “porn” etc in English would need translations of these in other languages. Plus, even if we consider only one language, semantic analysis can be very complex. But, other spaces are possible. For example, a language specific filter, even with the above limitations, might be applied to the message, and result in various data that would form a new space. We could then use this space along with the other spaces we have already described.

So each message can be regarded as an envelope, holding data in each space. Some data might be empty for a given message. For example, if you get an email from a friend, there might be no hyperlink domains in it.

We can find and draw clusters in each of the spaces. The method for finding clusters is the same, and described in Appendix A.

Given the clusters, we can graph them, as shown in these figures. These are derived from actual email accounts that we have analyzed. In each figure, a node (vertex) represents an item in that space (like a domain). The number next to the item's name is a measure of the number of messages which refer to that item. An edge (arc) connecting two nodes means that there is at least one message referring to both nodes. The number by the edge is a measure of how many such messages there are.

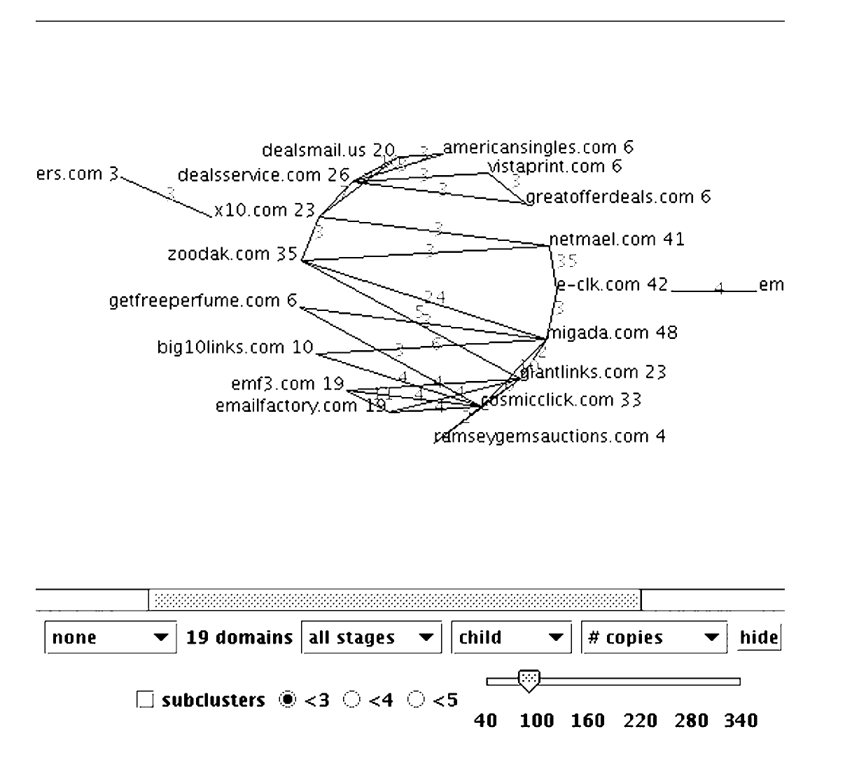

FIG. 2: A domain cluster—cluster of domains sending multiplicative messages

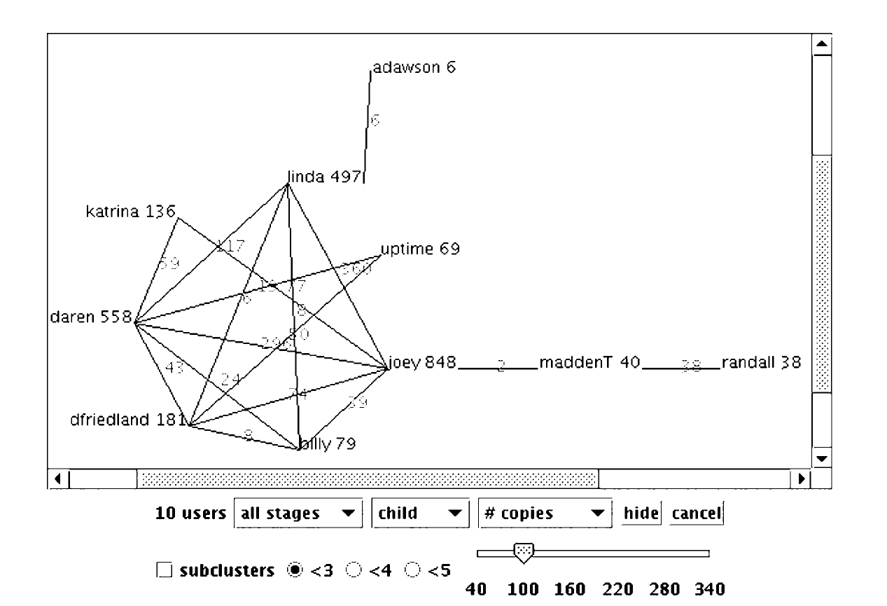

FIG. 3: A user cluster

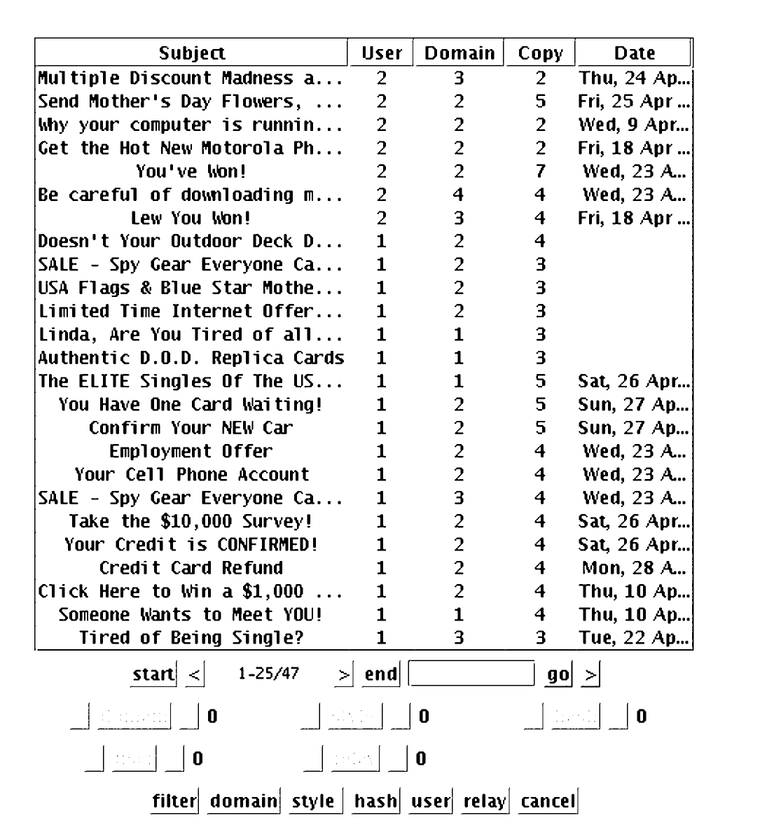

FIG. 4: A message group corresponding to the domain cluster in FIG. 2

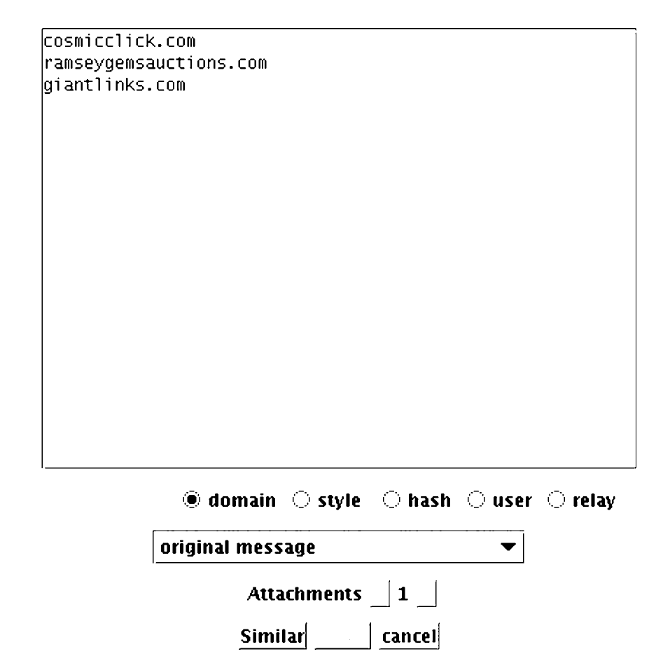

FIG. 5: Data extracted from a message in FIG. 4

The user can drill down to this level to investigate specific messages. Now suppose she, either using our system or other means, or a combination of these, reaches the conclusion that several of the domains in cluster are spammers. She can then decide that all the domains in the cluster are spammers. Then she can use our system to generate a blacklist, which is passed to a mailer, to reject future mail. Thus she can use the clusters as a “force multiplier”. The easiest way to see this is to look again at FIG. 2. There are only 19 domains. If she already considers, by whatever means, that, say, eight of these are spammer domains, then she may choose to infer that the remaining 11 domains are thusly spammer domains.

Based on our canonical reduction and hashing steps from Provisional Patent 60320046, our extraction of the various spaces from electronic communication and our ability to graph those spaces against each other has utility to a user.

These clusters provide an important data management and visualization tool to investigate a corpus of messages. Typically, there may be thousands or millions or more of these messages received every day. It may be too time consuming for an investigator to read every message or even most messages, to try to discern patterns. Plus, without our canonical reduction steps and the making of hashes to find same or similar messages, it is hard to find any such “same” or “similar” messages, when the authors might insert various types of randomness within their messages to make each unique.

When we said above that thousands or millions of messages might be received daily, we should say who might actually get those many messages. These include, but are not limited to, companies of any size, and Internet Service Providers (ISPs) of any size. Plus they could also include groups of individuals with email accounts at different mail providers, who have decided to band together, perhaps in part to exchange hashes of their messages to identify spam. These groups might exist only briefly, and only thence to do the above spam identification and rejection. Or groups might persist over many days or months or longer, to do the above. Such long lived groups may actually exist for a primary purpose that is not antispam related. For example, a group might be members of a common occupation, or share a common hobby.

For companies, ISPs and groups, there is another advantage to using our system. One way that spammers get email addresses is to send web spiders, which are automated probes, to search websites and harvest any addresses. This has lead some websites to adopt countermeasures that may be considered unsatisfactory by some:
1. Not putting any email addresses on webpages.
2. Writing an email address in a way that cannot be clicked on by the reader to open a message writing form. For example, if you write this in a webpage, then the reader can easily click on it and reply to you: “mailto:joe@bigcompany.com”. But a spider can harvest this. So you might write “mail me at joe at bigcompany dot com”. This assumes that the reader will understand that she must manually convert that to a valid address and type it out in a mail form, to contact you. Plus a spider may still be able to convert that to an address.
3. Write an email address on the webpage that will be used mainly to answer queries, and will be separate from your other accounts.
4. Not having the email addresses of many or all of your users publicly available on the website.

Using our system nullifies the unwanted harvesting of addresses. It does not prevent the harvesting, but it neutralizes the use of the harvested list for spam.

Once we have process the set of emails presented, we can start utilizing these correlations. We can determine relationships between the elements in a defined space, or correlate groups of elements across various defined spaces. Additionally, one can cross-correlate various communications spaces from disparate sources; allowing for the refinement of our understanding of all spaces involved. If you have multiple information sources related to the spacial domain of interest, you can verify various properties and attributes of that data space.

In the case of email we have three canonical domain information sources available to us:
1. email derived domain information
2.custom web crawler information of the email derived domains, and their page derived linked domains
3.lnformation from official registries such as the Internet Corporation for Assigned Names and Numbers (ICANN) and authorized registries for .com, .org, .net, .info, .name, etc that are appropriate to the domains under consideration

Given these sources of information, we could choose to perform any or all of the following actions algorithmically (including, but not limited to):
Extract the body link domains and determine clustering (using an exclude list).
   Determine clustering by domain names and IP address
Extract sender domain(s) from the bulk message envelope (BME).
Extract and validate the Relay chain(s) from the BME.
   (For example, if a relay is an invalid domain or IP, this suggests that the sender is writing false relay information to hide his trail.)
   (For example, if several canonically identical messages have the same body link domains, but different relay chains, this suggests that the sender is writing false relay information to hide his trail.)
Extract users related to various message clusters and/or spammer clusters (mailing list clusters)
Perform the Purified-data statistics on messages and BME
Perform various “reality checks” on the domains including, but not limited to,
   Do canonically identical messages in BME refer to different body link domains? (If so, this is typical of a spam message sent out by several associated spammers, who start with an original message and put in links to their own domains.)
   Do sender domain(s) from BME correspond to body link domains? (If not, then this is common in spam, where the spammer writes a false senderdomain, to mislead antispam software that just blocks against a list of spammer sender domains.)
   Do sender domain(s) from BME correspond to relay chain(s)?
   Do relay chain(s) correspond to body link domains?
Web crawl the website(s) links in the BME to some specified depth (using exclude list)
Acquire the site heuristics appropriate from these link domains
   Number of pages at each depth
   heuristics of the various pages
   links to other web sites, build Bulk Link Envelopes (BLE)
   determine BLE multiplicities etc.
Perform the purified-data statistics on pages, heuristic attributes, and BLE
Determine connectivity, topology, and multiplicity of domains in the BLE space(s)
Determine the Relative Link Weightings between the BME body link domains and BLE domains
   If enough web crawler data exists, calculate relative relationship rankings for domains
Extract all relevant data from various official registries (DNS, WHOIS, etc) for domains
   NSP
   ISP
   Hosting Agent
   Ownership (purported)
   Contacts for the various purposes (purported)
   email relays associated with Owner, Host, ISP or NSP
   IP address(es) associated with domain via these or other indices
Perform cluster analysis, and cross reference “registry space(s)” with other data spaces

Once we have determined a candidate domain and domain cluster set for a blocking list, we use the data from the other two canonical data spaces to “verify” and “clean” the candidate set. Once we have run all of the correlations and checks of interest, the resultant set of domain names and/or IP addresses can be output in the form of a blocking list. (We call this a blocking list, but it could be used to select messages for inclusion, or to promote them for special processing.) We can present the candidate RBL to an administrator to optionally edit ( add, enhance or delete entries) by utilizing internally extracted and extended data sets available in regards to the domain informations; including, but not limited to:
a. Existing RBL(s)
b. Relay paths
c. From signatures
d. Domain Clusters
e. Domain Near Field Info
f. Whois info & owner/host related domains
g. DNS info & owner/host related domains
h. NSLookup Info & owner/host related domains
i. Redirection Paths
j. IP spacial clustering
k. IP-space Near Field Info
l. Hosting Information
m. Bayesian/Word frequency/Dictionary specific analysis of spider-crawled domains

With these correlations we can achieve several communications management goals: classification, categorization, routing disposition, in depth analysis of the communications streams, etc. For email, as an example of one type of communications space, one could perform various actions (including, but not limited to) the following:
1. Find domains that issue unsolicited bulk email (spam) and thence block incoming email from or referring to those domains.
2. Block all incoming or outgoing electronic communications related to these domains (ping, ftp, http, etc), typically at the mail relay and/or firewall levels. Why would it be useful to block outgoing communications to those domains? As one example, imagine a private company with a firewall. Using our methods, it has found that some of the spam is pornographic and offensive to several of its employees. Obviously, it can block future incoming email with links to those domains. But it may also wish to prevent its employees from going directly to them, where we assume that some may already know of these domains. Hence it can block any outgoing http connections to those domains. As a second example, imagine that instead of a private company in the previous example, we have a school or school district.

All of the techniques described herein are applicable to many related communications spaces; including, but not limited to:

1. E-mail and related services

2. Small Message Services (SMS), alphanumeric paging systems, and similar technologies

3. i-Mode, m-Mode, various “rich” messaging services for mobile devices, etc.
4. Instant Messaging (IM) services, and similar technologies
5. digital fax services (corporate fax servers, etc)
6. Unsolicited telephone communications management
7. archives of electronic communications

Ex.2. Web pages/sites, or other external data stores (or archives thereof)

As in Example 1 with additions of:
1. web-link information from web spiders on large scale
2. clickstream data from websites (optional)
3. other external data stores with at least one common spacial element (optional)

The methods in Example 1 can be used here, and are enhanced by the above information that is specific to websites.

This allows for the correlation of data to reveal new meta-information, and subsequent meta-analysis of web-link relationships; which in turn, enhances the ability to classify some type of web-link relationships uniquely. By comparing content-body link domain groupings (cliques) in email spaces with similar structures in web crawler informations, and performing various heuristic comparisons (as laid out in Appendix B) we can identify “link-farms” in the web link space. Thus an RBL that includes domains that are elements of these identified “link farms” can be utilized to select domains/clusters to exclude from website relationship ranking; thereby increasing their relevance/utility.

Ex.3. IM, IRC, and functionally similar systems. (or archives thereof)

The methods in Example 1 can be used here, with the addition of temporal data, which is much more important in this space.

With these correlations we can identify IM spammers and robots. This allows us to selectively block all incoming or outgoing electronic communications related to these spammers/robots (IM, ping, ftp, http, etc).

Ex.4. SMS, pagers, and functionally similar systems. (or archives thereof)

As in Example 3 with the addition of canonical sender identification (phone number) With these correlations we can identify spam messages, spammers and spam domains. This allows us to selectively block all incoming or outgoing electronic communications related to these spammers/domains.

Ex.5. i-Mode, m-Mode, and functionally similar systems. (or archives thereof)

As in Example 3 with the addition of canonical sender identification (phone number)

With these correlations we can identify IM spammers and robots. This allows us to selectively block all incoming or outgoing electronic communications related to these spammers/robots (IM, ping, ftp, http, etc).

Ex.6. Fax Servers (or archives thereof)

Ex.7. Telemarketing calls (or archives thereof)

Ex.8. Call log space (or archives thereof)

As in Example 1 with the addition of canonical sender identification (phone number) With these correlations we can identify spam messages, spammers and spam domains. This allows us to selectively block all incoming or outgoing electronic communications related to these spammers/domains.

Ex.9. archives of electronic communications

Archives of electronic communications could be analyzed with our technology to extract information of general managerial interest, or to meet a specific legal requirement. Examples of legal requirement(s) might include, but are not limited to, the following:
1. Informational subpoenas requesting all records in a data store related in a particular fashion.
2. SEC archiving/reporting requirements for various corporations (examples: IM archives for financial corps, SEC_{—}17a-4).
3. Sarbanes-Oxley Act archiving/reporting requirements for corporations. For very large archival stores requiring keyword searching it may be useful to use our technology in conjunction with an indexed search engine like Google.

(End of examples.)

Our communications categorization, classification, analysis, and management technology simplifies the efforts required to manage the utility and usability of various communications modes. One major goal of this invention is to enhance the usability of these channels while maintaining communications privacy. As such, our users do not need access to any or all of the original messages, in order to do analysis.

We use the example of email for illustration. Look at FIG. 8. Not having access to the original message means that if you press the leftmost button, “message”, the window shows nothing in its main panel. But you still have the metadata and the graphs. So for example, you can find messages with a style bit “Relays—invalid IP”, which means that these messages purported to arrive via relays that cannot have existed. You could use this as an indicator of spam, without knowing the original messages. This is an example where we look at the header. As another example, where we look at the body, you can find messages with invisible text, and regard this as an indicator of spam, again without knowing the original messages.

As yet another example, suppose you know, from data outside your system, that a domain, gamma, is a spammer domain. You bring up a domain cluster graph and find gamma in a cluster with domains chi and kappa. You might use this to infer that chi and kappa are also spammers. But perhaps you hesitate in concluding this. You can use that cluster and drill down to investigate other properties. Say you then find that half the messages referring to chi and a third of the messages referring to kappa use invisible text or have unknown HTML tags. Based on all this, you might reasonably conclude that chi and kappa are definitely spammers. Again, you never needed the original messages to do this.

Why does this have utility? Isn't it better for the user to have access to some or all of the original messages? In some cases, no! Imagine that you are a corporation. You get a lot of incoming messages, containing mostly spam. These days, a system administrator might have a significant part of her time being devoted to tuning whatever antispam methods you are using. Currently, system administrators typically can read any message. But you have some mail that is not spam, and highly sensitive. Our system lets you assign a mail administrator who does not need read access to any of the mail. Or you can deploy our system in a mode that lets her look at messages, but only if, say, 4 or more copies of a message have been received. The “4” is adjustable, but not by the mail administrator. The point is that highly sensitive messages are far more likely to exist as only a few copies (typically one), whereas spam often exists as multiple copies.

Thus we can split off the mail duties from general sysadmin duties, and the mail administrator does not need “root” access, in the language of the unix and linux operating systems. (Other operating systems also let you define similar accounts.) Of course, if there is only one sysadmin, then this is moot, because we need at least one person with root access, for other sysadmin tasks.

But many companies now have several sysadmins. If administrative handling of messages has become so important that one or more sysadmins deal with it exclusively, then you can use our system to restrict their access and still have them carry out their duties.

Alternatively, suppose you have a sysadmin who is handling the mail as part of her duties. It is a sysadmin because she needs root access to do this. But if you use our system, then these duties can be delegated to a non-sysadmin, possibly freeing up her time for more important work.

Appendix A:

How We Find Clusters We have the set of messages {x[1], . . . ,x[n]}. Here, we have applied our canonical reduction steps and hashed the resultant messages. Then we compared messages' hashes with hashes from other messages, in order to find messages with the same hashes. We combined these identical messages, which saves space and reduces the size of the problem. Thus, each x[i] has a field, “mult”, which describes the number of copies of this message that were in the original data. The field is used below to define the distance vector for the edge between two vertices in a cluster.

We want to find clusters based on a particular type of data in each x[i], where it can have zero or more different values of that data type. So for each x[i], we can find a corresponding set S[i] of values. We do not discuss further how we find S[i]. The details of these are specific to each type of data, and to the particular type of electronic communication that x[i] represents (email, SMS, IM etc).

Given that we can extract S[i] from each x[i], the following algorithm is used to find clusters.

Definition: An “item” is a member of at least one S[i], for some i.

Definition: A class called “ItemLink”, which encapsulates an item and a set of links to other ItemLinks. A link exists if and only if there is at least one message x[i] whose S[i] contains both items. Each link contains both a pointer to another ItemLink and a non-negative integer, which is a count of how many messages contained both items.

This is symmetric. If ItemLink alpha has a link to ItemLink beta, then beta has a link to alpha. We can therefore consider the links as bidirectional. Each link is directional, but since we can go to the item it points to, and come back via another link, we can consider them as bidirectional.

Definition: Let M be the set of all ItemLinks found from the data. We call M the “adjacency matrix”. [“An Introduction of Data Structures and Algorithms” by J Storer, Springer-Verlag 2002, p. 291. It describes the adjacency matrix and related concepts].

M describes the correlations between the items. Because it is typically sparse, it is very inefficient to store it as a simple matrix. Hence we have made the ItemLink class. Below, we describe how we find M. Given this, we then derive clusters from it.

Definition: An “Exclude” list is a list of names of items.

The Exclude list serves a special purpose, in the definition of a cluster:
Definition: A “cluster” is a set C of ItemLinks, each of whose links points only to other members of C, or names on an Exclude list. (The latter might be empty.)

In other words, a cluster is closed. If you start at any member, and follow any of its links, you will always stay inside the cluster, or end up on the Exclude list.

Finding M

M is stored as a hashtable [“The Art of Computer Programming-Volume 3” by D Knuth, Addison-Wesley 1998, p. 513.] It will be used to go from a name of an item to the ItemLink with that name. We need this for fast lookup of ItemLinks.

```
  for(i=1 ;i<=n;i++)
{
    extract S[i] from x[i];
    w=number of copies of x[i]=x[i].mult;
    for(j=1 ;j<=size of S[i];j++)
    {
      // name of an item
      name0=j−th member of S[i];
      if(M has no ItemLink with name0)
      {
        make a new ItemLink with name0 and w and with
        links to the other members of S[i];
        put the ItemLink into h, under the key=name0;
      }  else  {
        // x=an existing ItemLink for name0
        x=M.get(name0);
        for(k=1 ;k<=size of S[i];k++)
        {
          name1 =k−th member of S[i];
          // ignore autocorrelation
          if(name1 ==name0) continue;
          if(name1 in x's links)
            add w to name1's link;
          else
            add (name1,w) to x's links
        } //k
      }
    }// j
}// i
```

Finding Clusters
1. From M, get a list of its ItemLink values, L={L[0], . . . ,L[q]}.

2.while (L has entries)

```
{
    make a new cluster, C;
    // recursively add L[0] and its links to C
    add2cluster(C,L[0]);
    remove C's ItemLinks from L;
}
```

Thus, we start with the first entry in L, and pull it out into a cluster, along with anything linked to it. We follow these links recursively until we cannot add anything more to the cluster. The cluster is then closed. We remove the cluster's members from L. Then we repeat until L is empty.

3. the recursive routine add2cluster( ) is:

```
add2cluster(ItemLink a,Cluster C)
{
    add a to C;
    get l=set of links in a;
    if(l is empty) return;
    for(each link x in l)
    {
        if(C already has an ItemLink with x's name)
            continue;
        // do NOT expand the cluster thru x if it
        // is on the Exclude list
        if(Exclude list has x) continue;
        ItemLink q=get ItemLink from M with x's name;
        add2cluster(q,C);
    }
    return;
}
```

The Exclude list has utility. Suppose we are looking at domains in email in order to detect spam. Then this list might have domains of companies that we are willing to stipulate, a priori, as not being spammers. We need this, in part to prevent a cluster from growing because spammersmight deliberately put in clickthroughs to domains which they do not control, in order to contaminate our results. For example, suppose a message which has high multiplicity has several spammer domains. But the spammer also adds ibm.com. In add2cluster( ) below, we do notexpand our cluster by then adding domains that ibm.com links to.

Appendix B:

Finding Link Farms We want to find “link farms”, which are a set of websites with different base domains, which act in concert to artificially inflate links to a particular web page. These links cause that page to have high rankings in search engines.

We assume that we, or an associated third party, have run spiders over a substantial portion of the web, obtaining a set of web pages. We define substantial to mean over 10% of the estimated total number of web pages in existence at the time of our survey. If a third party exists, it might be an owner of a search engine (e.g. Yahoo or Google).

So given a web page P in this set, we can find the other pages in the set that point to it.

Now let us go back to our corpus of electronic communications. Let S be a set of related domains, with n domains. We find S based on the methods in our Provisional Patent 60320046,and Provisional Patent 60/481745.

If every domain in S is connected to every other, there is a total of n*(n−1)/2 such links. Mathematically, such a maximally connected set is called a “clique”. [11] Thus for every S, that is not necessarily a clique, we can find the number of internal links, then divide it by the above total to find the fractional internal link density of S.

We have also removed from S any domains that are in an “Exclude” list. Typically, this list consists of domains that we define to be “good”, like any that end in *.edu, *.gov, *.mil, *.ac.uk. Plus it also consists of domains of companies or organizations that we define as unlikely to be spammers. Like redcross.org or sciam.org (Scientific American).

Next, we let the administrator change the definition of a clique. One simple way is to vary a fraction, f, between 0 and 1 inclusive. Then if S has a link density >=f, we define S to be a clique. In other words, this is a slightly more permissive definition of clique. Other functional definitions are also possible.

Typically, S will be added algorithmically to our RBL. But we can also algorithmically search S to find subsets that are cliques. Let these cliques be C={C1, C2, . . . , Cm}. We can pass these to a search engine, which is either run by us or by a third party, with the recommendation that these be considered link farms, and that the search engine should not use the links from these domains to other domains, when calculating the weightings of the latter.

Specifically, whoever possesses the spider data can aggregate the number of links from web pages outside the purported link farm to domains in it. Then by comparing these incoming links to the density of internal links, and to the outgoing links from the farm, we can get an indication of whether the link farm is indeed that. Because a link farm might have a lot of internal connections between their members, to raise their members rankings in a search engine. And these members might then point to external sites, which are trying to elevate their rankings. (The external sites may have paid the link farm for this “service”.) Or, there might not be any external sites; the link farm is raising its rankings to drive searches to itself. In either case, the weakness of link farms is that there are often relatively few links to them.

Search engines are probably already doing similar techniques to find link farms. Our novelty here is twofold. First, we can supplement their techniques by having an algorithmic means to submit to them sets of purported link farms. They can then use their existing techniques on these, to see if the link farms are indeed so. Second, our source of data is entirely separate from the space of web pages that search engines troll. Often, it might be, but is not limited to, email. The point is that this approach attacks link farms in an entirely new way. (Implicitly, a third reason is of course that we are using our system described here and in our earlier Patents Pending to extract from the data the possible link farms.)

But why should link farms also be spammers? Some are not. But it is costly to own and maintain a set of separate domains and web pages on those domains. It is more than just the simple costs of a generic website. Search engines are continually refining their techniques in web space to find these link farms. So link farmers need a continual upgrading of countermeasures for their web pages. Plus, there are migration costs to move to new domains when a set of domains in a link farm has been definitely identified as such by the major search engines. So having built a link farm, a link farmer might want to realize an extra revenue source, by issuing bulk email with links to the link farm. Our method of detecting this and passing the members of the link farm to a search engine means that we attack his sources of income in the email and search spaces.

1. A method for processing a set of electronic messages to extract clusters in any of the spaces of metadata appropriate to that messaging modality.

2. The method of claim 1, where the messages are email, and the metadata spaces include domain, hash, style, relay and user email address.

3. The method of claim 2, where the messages are Instant Messages or SMS, and the metadata spaces include domain, telephone number, hash, style, relay and user IM or SMS address.

4. The method of claim 1, where the messages are email, and the domain and/or relay metadata clusters are used to construct or augment a Real time Block List (RBL).
